(19) United States
(12) Patent Application Publication
(10) Pub. No.: US 2006/0020390 A1
(43) Pub. Date: Jan. 26, 2006

(54) Method and system for determining change in geologic formations being drilled

(76) Inventor: Robert G. Miller, Frisco, TX (US)

Correspondence Address: FISH & RICHARDSON P.C., P.O. BOX 1022, MINNEAPOLIS, MN, 55440-1022, US

(21) Appl. No.: 10/896,838

(22) Filed: Jul. 22, 2004

(51) Int. Cl. G06F 19/00

(52) U.S. Cl. 702/11

(57) ABSTRACT

The present invention provides a method and system for determining change in geologic formations being drilled. In accordance with one embodiment of the present invention, a method for determining change in geologic formations includes receiving a plurality of values of formation change indicators. For at least one formation change indicator, the value is adjusted based on operating conditions.

### TECHNICAL FIELD

The present invention relates generally to the field of drilling in subterranean formations, and more particularly to a method and system for determining change in geologic formations being drilled.

### BACKGROUND

Subterranean deposits of coal, also referred to as coal seams, contain substantial quantities of entrained methane gas. Production and use of methane gas from coal deposits has occurred for many years. Substantial obstacles, however, have frustrated more extensive development and use of methane gas deposits and coal seams. The foremost problem in producing methane gas from coal seams is that while coal seams may extend over large areas of up to several thousand acres, the coal seams are often fairly thin in depth, varying from a few inches to several meters. Thus, while the coal seams are often relatively near the surface, vertical wells drilling into the coal deposits for obtaining methane gas can only drain a fairly small radius in the coal deposits. Further, coal deposits are sometimes not amenable to pressure fracturing and other methods often used for increasing methane gas production from rock formations. As a result, once the gas easily drains from a vertical well bore in a coal seam, further production is limited in volume. In response to these limitations, horizontal drilling patterns have been tried in order to extend the amount of coal seams exposed by a well bore for gas extraction.

### SUMMARY

The present invention provides a method and system for determining change in geologic formations being drilled. In particular, certain embodiments of the invention provide a system and method using data integration and predictive analysis for maintaining drilling operations within a thin or narrow formation.

In accordance with one embodiment of the present invention, a method for determining change in geologic formations includes receiving a plurality of values of formation change indicators. For at least one formation change indicator, the value is adjusted based on operating conditions. Specifically, a formation change is determined based on the received plurality of values of formation change indicators.

The technical advantage of the present invention include providing a method and system for data integration and predictive analysis of a subterranean formation. In particular, a technical advantage may include adjusting values of indicators of formation change based on drilling operations. This adjustment may allow for more accurate monitoring of formation change in a subterranean formations. More accurate monitoring of formation changes allows for more efficient drilling of thin subterranean formations and greatly reduces costs and problems associated with other systems and methods. Another technical advantage of one or more embodiments may include providing a system and method for drilling in any thin geologic formation.

Other technical advantages will be readily apparent to one skilled in the art from the figures, descriptions and claims included herein. Moreover, while specific advantages have been enumerated above, various embodiments may include all some or none of the enumerated advantages.

### DESCRIPTION OF DRAWINGS

FIG. 1 is a schematic diagram of a drilling system in accordance with one embodiment of the present invention;

FIG. 2 is a block diagram illustrating an exemplary steering system of FIG. 1;

FIG. 3 is an exemplary flow diagram illustrating an example method for providing data integration and predictive analysis of a subterranean zone;

FIGS. 4A-B are exemplary flow diagrams illustrating example methods for the assessment step illustrated in FIG. 3; and

FIG. 5 illustrates one embodiment of a display of formation change indicators.

Like reference symbols in the various drawings indicate like elements.

### DETAILED DESCRIPTION

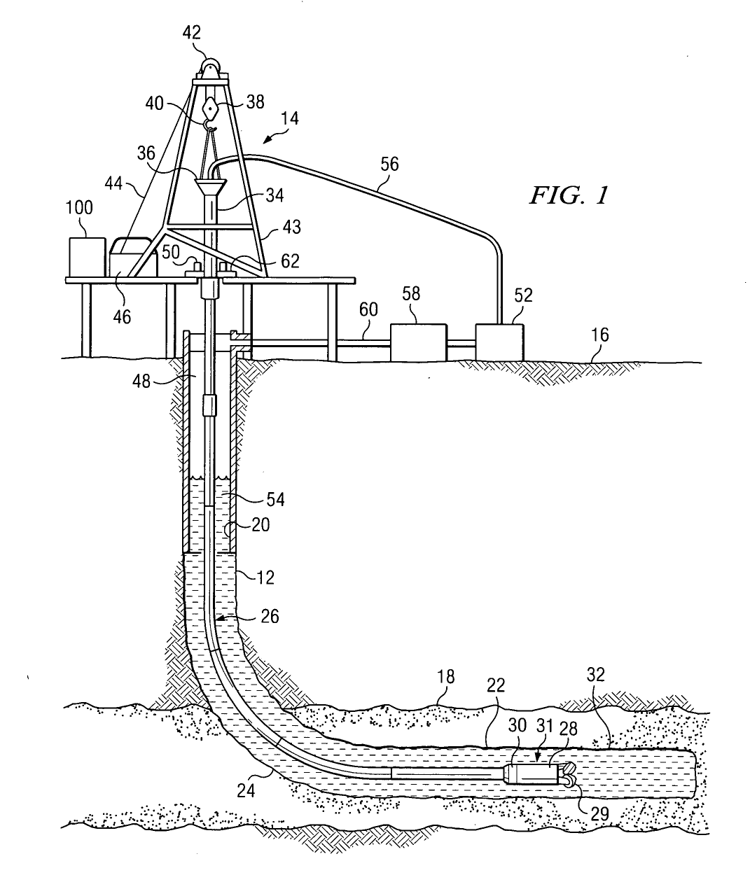

FIG. 1 is a schematic diagram of a drilling system 10 for drilling within a subterranean formation using data integration and predictive analysis in accordance with an embodiment of the present invention. In particular embodiments, the subterranean formation is an unconventional reservoir such as a coal seam. However, it should be understood that other subterranean formations including conventional oil and gas reservoirs can be similarly drilled using system 10 of the present invention to remove and/or produce water, hydrocarbons and/or other fluids, including gases, from the zone, to treat minerals in the zone prior to mining operations, or to inject, introduce, or store a fluid or other substance in the zone. The formation may, for example, be a thin formation having a thickness of less than ten feet, may include inconsistent bedding planes, or be undulating or faulted.

Referring to FIG. 1, system 10 includes a drilling rig 14, an articulated well 12, and a well bore pattern 32. Rig 14 drills articulated well 12 that extends from a surface 16 into a subterranean formation 18. From the terminus of articulated well 12 or articulated portion of well 12, rig 14 proceeds to drill well bore pattern 32. Articulated well 12 may be any appropriate well including a portion that is deviated from vertical, such as slanting, sloping or radiused. In other embodiments, the well may be a vertical or other suitable well.

Articulated well 12 extends from surface 16 to subterranean formation 18. Articulated well 12 includes a first portion 20, a second portion 22, and a curved or radius portion 24 interconnecting the portions 20 and 22. In FIG. 1, portion 20 is illustrated substantially vertical; however, it should be understood that portion 20 may be formed at any suitable angle relative to surface 16 to accommodate surface 16 geometric characteristics or attitudes and/or the geometric configuration or attitude of subterranean formation 18. Portion 22 lies substantially in the plane of subterranean formation 18. Substantially horizontal portion 22 may be formed at any suitable angle relative to surface 16 to accommodate the geometric characteristics of subterranean formation 18 and may undulate in subterranean formation 18. Articulated well 12 may be logged and/or measured during drilling in order to monitor indicators of formation change, i.e., formation change indicators, to assist in maintaining drilling operations within subterranean formation 18. As used herein, a formation change indicator is a parameter that in at least one circumstance strongly indicates a change in a formation being drilled, such as from one formation to another disparate formation. Formation change indicators may also or instead indicate anomalous formation changes such as faults, fractures or inconsistencies within a formation as, for example, thicker formations. Logging while drilling (LWD) may monitor the following formation change indicators: resistivity, density, sonic, gamma, oriented gamma, a combination of the foregoing, or other appropriate indicators. Measurement while drilling (MWD) may monitor the following formation change indicators: inclination, azimuth, annular pressure, vibration, tool face, a combination of the foregoing or any other appropriate indicators. Values determined by LWD and MWD may also assist in drilling well bore pattern 32 within subterranean formation 18. Other formation change indicators may include operating conditions such as standpipe pressure, rotary torque and rate of penetration.

After the drilling orientation has been successfully aligned within and/or in subterranean formation 18, drilling is continued to provide well bore pattern 32 in subterranean formation 18. In FIG. 1, well bore pattern 32 is illustrated substantially horizontal corresponding to a substantially horizontally illustrated subterranean formation 18; however, it should be understood that that well bore pattern 32 may be formed at any suitable angle corresponding to the geometric characteristics of subterranean formation 18. During this operation, MWD, LWD and rig measurements may be employed to control and direct the orientation of drill bit 29 in order to substantially maintain well bore pattern 32 within the confines of subterranean formation 18 and to provide substantially uniform coverage of a desired area within subterranean formation 18. Well bore pattern 32 may lay within sloped, undulating, or other inclinations of subterranean formation 18. During the process of drilling well bore pattern 32 and articulated well 12, drilling rig 14 applies weight and torque to drill string 26 or otherwise manages drill string 26 to drill appropriate well bores.

Rig 14 includes drill string 26 supported by kelly 34, which in turn is connected to swivel 36. Swivel 36 allows kelly 34 and drill pipe to rotate. The drilling progress or rate of penetration (ROP) is measured from the rate that the height of kelly 34 decreases during drilling operations. Swivel 36 is suspended from hook 40 of travelling block 38. Draw works 46 controls the upward and downward motion of travelling block 38 via drilling line 44. Drilling line 44 runs from the drum of draw works 46, up to crown block 42 and then over several loops back and forth between crown block 42 and travelling block 38. Crown block 42 is affixed to mast 43. The end of drilling line 44 is clamped or otherwise affixed to mast 43. This termination point may also serve as a sensor point for determining weight on bit (WOB) via drill string 26. Drill string 26 includes a motor 28 and drilling bit 29 and may collectively be referred to as a bottom hole assembly (BHA) 31. BHA 31 may also include MWD instruments 30 to measure formation change indicators used to control the orientation and direction of drill string 26 for substantially maintaining drilling within subterranean zone 18.

Mud pump 52 pumps drilling fluid, or mud 54 from mud tank, or pit, 58 to drill string 26. Mud pump 52 is connected to drill string 26 via mud hose 56, which may be connected to a standpipe. Standpipe pressure may be measured by any appropriate instrument. After mud 54 enters drill string 26, mud 54 travels to BHA 31 via drill string 26, where it drives the motor of BHA 31 and exits bit 29. After exiting bit 29, mud 54 scours the formation and assists in lifting cuttings to surface 16 via the annulus of drill string 26. The returning mud 54 is directed to mud tanks 58 through flow line 60. Mud tanks 58 may include shale shakers or other appropriate devices to remove cuttings from the returned mud 54. Sensors may be included in mud tank 58 to measure characteristics of mud 54 such as, for example, mud weight, mud resistivity, mud temperature, mud density, and other appropriate characteristics.

In operation, articulated well bore 12 and well bore pattern 32 are drilled by applying weight to and rotating drill bit 29. A rotary table 62, which is mounted on rig floor 64, drives the rotation of drill string 26 and thus transmits torque to drill bit 29. Rotary table 62 may provide a measuring point for rotations per minute (RPM) of and rotary torque applied to drill string 26. Bit 29 may alternatively or additionally be rotated by downhole motor 28 and may be independent of drill string 26. In this case, mud 54 pumped through drill string 26, flows through motor 28 to turn bit 29. Further, motor 28 may be configured with an angular subassembly which, when oriented in a given altitude, allows the wellbore trajectory to be altered. As discussed above, mud 54 carries the cuttings produced by drill bit 29 out of well bore pattern 32 through the annulus between the drill string 26 and well bore 12. During operation, determinations of MWD and LWD parameters and operating conditions may be made and provide to steering system 100.

Steering system 100 assesses, based on formation change indicators and operating conditions, changes in subterranean zone 18 during drilling operations and indicates these assessments to a user of system 100. The value of one or more formation change indicators may be adjusted based on operating conditions. Such adjustments may be continuous, periodic or as necessary. For example, operating condition adjustments may not be necessary when formation change is the cause of a change in formation change indicators.

Operating conditions are parameters associated with the operation of rig 14. Operating conditions may include one or more of the following: rate of penetration, standpipe pressure, annular pressure, vibration, motor differential pressure, weight on bit, measured depth, rotary torque, fluid flow rate, mud weight, and others. Steering system 100 may be used to maintain horizontal drilling within a formation, to give early indications of formation changes to pick core points and/or to identify equipment problems such as worn bit or washed out drill string tubular. For example, the system may be used in conventional reserve horizontal drilling where a formation sweet spot is being targeted. In this application, for example, well bore trajectory at a certain elevation in the formation (e.g. near the top) may be maintained using indicators that identify differences in formation consistency between the top and bottom of the formation. While steering system 100 is illustrated as a part of rig 14, steering system 100 may be separate from rig 14 and/or on-site or off-site.

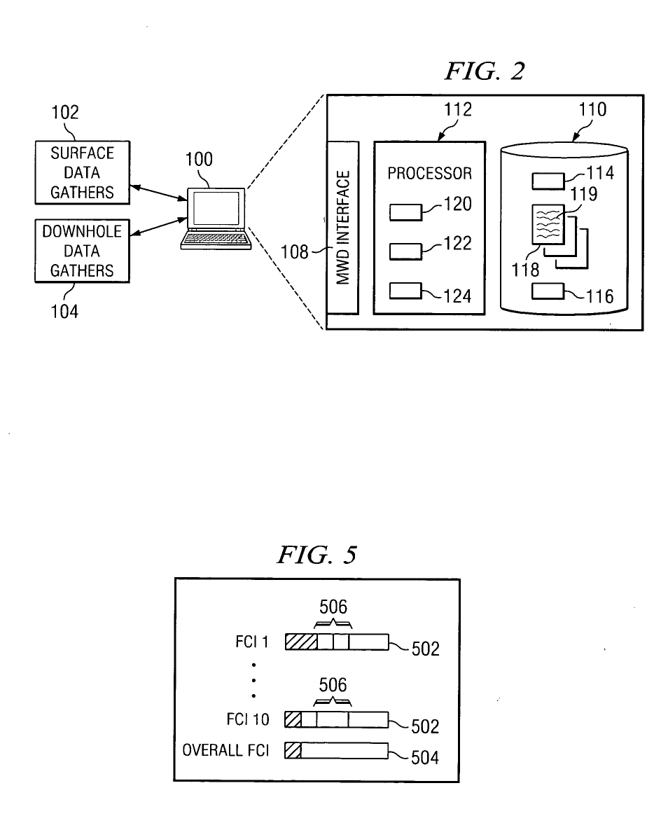

FIG. 2 illustrates one embodiment of steering system 100 of FIG. 1. In one embodiment, system 100 provides data integration and predictive analysis for aiding drilling operations and/or steering system 100. At a high level, system 100 is coupled to and receives formation change indicators and/or operating conditions from surface data gathers 102 and downhole data gathers 104. Based on the received data, system 100 assesses changes in subterranean zone 18 during drilling operations and indicates these assessments to the user of system 100.

Surface data gathers 102 and downhole data gathers 104 comprise instrumentation that measure formation change indicators and/or operating conditions and provides their values to system 100. Alternatively, the measurements of formation change indicators and/or operating conditions may be manually determined, in which case their values may be manually inputted into system 100. It will be understood that reference to “value” may be used interchangeably with “an average of a selected number of values,” so the term “value” also refers to “an average of a selected number of values,” where appropriate. For example, the average may span a specified period of time (e.g., 15 sec, 30 sec, 45 sec, etc.) or include a specified number of data points (e.g., 3, 10, 20, etc.). As discussed above, formation change indicators and/or operating conditions may include MWD measurements, LWD measurements, rig measurements, and other suitable measurements. In one embodiment, down hole data gathers 104 comprises MWD instrumentation 30 that communicates values of formation change indicators via mud pulses, electromagnetic, acoustic or other wireless telemetry methods. Values may be alternatively communicated by wireline, fiber optic, tubular conveyance or other hardwire conduits.

System 100 includes a Graphical User Interface (GUI) 106, an MWD interface 108, a memory 110, and a processor 112. The present disclosure includes a repository of conversion files 119 that may be stored in memory 110 and may be processed by processor 112. While system 100 is illustrated as a computer, system 100 may comprise any appropriate processing device such as, for example, a mainframe, a personal computer, a client, a server, a workstation, a network computer, a personal digital assistant, a mobile phone, or any other suitable processing device. System 100 may be operable to receive input from and display output through GUI 106.

GUI 106 comprises a graphical user interface operable to allow the user of system 100 to interact with processor 112. The terms “system 100” and “user of system 100” may be used interchangeably, where appropriate, without departing from the scope of this disclosure. Generally, GUI 106 provides the user of system 100 with an efficient and user-friendly presentation of data provided by system 100. GUI 106 may comprise a plurality of displays having interactive fields, pull-down lists, and buttons operated by the user. Alternatively, system 100 may comprise any appropriate indicator operable to convey formation changes to a user of system 100 such as, for example, a display, color-coded lights, alerting noise, or any other suitable indicator.

System 100 may include MWD interface 108 for receiving MWD signals from MWD instruments 30 and converting the signal for use with system 100. Generally, interface 108 comprises logic encoded in software and/or hardware in any suitable combination to allow system 100 to receive values of formation change indicators measured by MWD instruments 30. While MWD interface 108 is illustrate as a part of system 100, MWD interface 108 may be disparate from system 100 and coupled to system 100.

Memory 110 may include any memory or database module and may take the form of volatile or non-volatile memory including, without limitation, magnetic media, optical media, Random Access Memory (RAM), Read Only Memory (ROM), removable media, or any other suitable local or remote memory component. In this embodiment, memory 110 includes a filtering range file 114, a tolerance range file 116, and repository of conversion files 118, but may also include any other appropriate files. Filtering range file 114 comprises instructions, algorithms or any other directive used by system 100 to identify one or more ranges of reliable values associated with each formation change indicator and operating condition. The term “each,” as used herein, means every one of at least a subset of the identified items. In the case a value is outside a filtering range, the value is discard and may comprise noise. Filtering range file 114 may be created by system 100, a third-party vendor, any suitable user of system 100, loaded from a default file, or received via network.

Tolerance range file 116 instructions, algorithms or any other directive used by system 100 to identify one or more ranges of each formation change indicators and operating condition that indicates tolerable variation in values of the associated parameter. For example, a tolerance range may indicate expected variation in values of a formation change indicator while drilling operations are within subterranean formation 18. In this case, values within the tolerance range may not indicate significant or any formation changes. As another example, a tolerance range may indicate expected variation in measurements due to noise inherent in the measuring instrumentation. In this case, values within the tolerance range may not indicate significant or any formation changes. In one embodiment, tolerance ranges of a formation change indicator and/or operating condition is a subset of the associated filtering range. In this embodiment, values that lie outside the tolerance range and within the associated filtering range may indicate significant changes in the formation being drilled. Filtering range file 114 may be created by system 100, a third-party vendor, any suitable user of system 100, loaded from a default file, or received via network.

Conversion file 118 comprises instructions, algorithms, data mapping, or any other directive used by system 100 to convert a value of a formation change indicator and/or operating conditions to a corresponding value on a scale operable to indicate formation changes. As used herein, convert means to swap, translate, transition, or otherwise modify one or more values. Conversion file 118 may be dynamically created by system 100, a third-party vendor, any suitable user of system 100, loaded from a default file, or received via network. The term “dynamically” as used herein, generally means that the appropriate processing is determined at run-time based upon the appropriate information. Moreover, a conversion file 118 may be accessed one or more times over a period of a day, a week, or any other time specified by the user of system 100 so long as it provides scaling function 119 upon request.

Scaling function 119 is one or more entries or instructions in conversion file 118 that maps a value of a formation change indicator and/or operating condition to a corresponding value on a selected scale. As used herein, “select” means to initiate communication with, retrieval of, or otherwise identify. The selection of the scale may be based on any appropriate characteristic such as, for example, ease of use, association with a formation change indicator, or any other suitable characteristic. Scaling function 119 may comprise a mathematical expression based on any appropriate programming language such as, for example, C, C++, Java, Pearl, or any other suitable programming language. For example, scaling function 119 may comprise an algebraic, trigonometric, logarithmic, exponential, a combination of the foregoing, or any suitable mathematical expression. Moreover, different values of a formation change indicator and/or operating conditions may be associated with disparate mathematical expressions. For example, scaling function 119 may comprise an algebraic expression for a first range of values and an exponential expression for a second range of values. Alternatively, scaling function 119 may comprise any appropriate data type, including float, integer, currency, date, decimal, string, or any other numeric or non-numeric format operable to identify a mathematical expression for mapping a value of a formation change indicator and/or operating condition to a selected scale. It will be understood that every value received by system 100 may not be associated with a corresponding scaling function 119 and thus a scaling function 119 may only be provided for a subset of the received values. Additionally, formation change indicators and/or operating conditions may be associated with disparate scaling functions 119 and thus each received value may be associated with a disparate scaling function 119. In one embodiment, a value of an operating condition may be associated with multiple scaling functions 119 and thus multiple scaled values may be determined from a single value of an operating condition. In this embodiment, the disparate scaled values are used to adjust disparate formation change indicators.

Processor 112 executes instructions and manipulates data to perform operations of system 100. Although FIG. 1 illustrates a single processor 112 in system 100, multiple processors 112 may be used according to particular needs and reference to processor 112 is meant to include multiple processors 112 where applicable. Processor 112 may include one or more of the following features and functions: point-to-point comparison, trailing average comparison of individual streams of values of formation change indicators, forward extrapolations based upon an individual stream of values of formation change indicators, point-to-point differential, trailing average indicators, forward extrapolations based on point-to-point or trailing average calculations, a combination of the above, or others. In the illustrated embodiment, processor 112 executes conversion engine 120, assessment engine 122, and alerting engine 124. Conversion engine 120 filters received values, converts values based on associated scaling functions 119, adjusts the converted values based on changes in operating conditions, and forwards the adjusted values to assessment engine 122. After receiving values of formation change indicators and/or operating conditions, conversion engine 120 retrieves associated filtering ranges from filtering range file 114. Conversion engine 120 discards all values that fall outside their associated filtering range. After filtering the values, conversion engine 120 retrieves scaling functions 119 from conversion file 118 associated with each received value. Based upon the retrieved scaling functions 119, conversion engine 120 converts each value to a corresponding value on the selected scale. For those values discarded, conversion engine 120 may use a preceding value or preceding average of values to convert to the selected scale. After converting the values, conversion engine 120 determines the extent that each converted value results from operating conditions. Based on this determination, conversion engine 120 adjusts the converted value to substantially remove the effect of the operating condition. In one embodiment, conversion engine 120 subtracts a value associated with a change in operating condition from a converted value of a formation change indicator. For example, conversion engine 120 may determine an increase or decrease in a converted values of an operating condition, at which point conversion engine 120 may subtract this increase or decrease from an associated formation change indicator. Alternatively, conversion engine 120 may determine the value of the change in the operating condition prior to converting to the selected scale. In this case, the change is converted to the scale which is then subtracted from the associated formation change indicator. As discussed above, a change in an operating condition may be used to adjust multiple formation change indicators, so multiple scaling functions 119 may be associated with the operating condition. In this case, each scaling function 119 may convert the same value (or change in value) to disparate values on the scale for adjusting disparate formation change indicators.

Conversion engine 120 may adjust several formation change indicators based on one or more operating conditions. For example, annular pressure may be adjust by one or more of the following: mud weight, fluid flow rate, standpipe pressure, vertical depth, or others. Vibration may be adjusted by standpipe pressure, weight on bit, or others. ROP may be adjusted by weight on bit or other appropriate operating conditions. Further, prior to using standpipe pressure to adjust other parameters, standpipe pressure may be adjusted by one or more of the following: fluid flow rate, WOB, and others. These examples are not intended as an exhaustive list but other embodiments may include other combinations of formation change indicators and operating conditions. In short, conversion engine 122 includes any suitable hardware, software, firmware, or a combination thereof operable to convert a value of a formation change indicator to a scale and adjust the value based on operating conditions. It will be understood that while connection engine 120 is illustrated as a single multitask module, the features and functions performed by this engine may be performed by multiple engines.

After adjusting the values, conversion engine 120 forwards the adjusted values of the formation change indicators to assessment engine 122. Assessment engine 122 determines whether the adjusted values in combination indicate significant change in subterranean zone 18 and if so, notify a user of system 100. In one embodiment, assessment engine 122 retrieves the tolerance ranges from tolerance range file 116, at which point assessment engine determines the difference between each value and a corresponding tolerance range. In this embodiment, assessment engine 122 sums the difference to determine an overall formation change indicator as illustrated in FIG. 5. Alternatively, conversion engine 120 may combine preselected groups of adjust values and determine if these combined values fall outside their corresponding tolerance range. In this alternative embodiment, assessment engine 120 retrieves tolerance ranges from tolerance range file 116. Assessment engine 122 sums the tolerance ranges of each preselected group and sums the adjust values within the preselected group. For example, the tolerance ranges of annular pressure and oriented gamma may be summed as a preselected group. After combining the ranges, assessment engine 122 determines if the combined values falls outside the tolerance range of the combined group. If so, assessment engine 122 notifies user of system 100 by, for example, displaying the value and range on a display. In yet another embodiment, assessment engine 122 may notify the user of system 100 if a certain number of adjusted values fall outside their tolerance ranges.

Alerting engine 124 communicates threshold violations to user of system 100. In one embodiment, alerting engine 124 retrieves threshold values from threshold file 118. Alerting engine 124 compares received values to the retrieved threshold values and in response to determining violations, alerting engine 124 communicates an alert to user of system 100. Additionally, alerting engine 124 may perform the following features and/or functions: flag a selected percentage of values being rejected from each measured variable, flag selected percentage changes in point to point, trailing average and/or differential values, notify for selected percentage changes in measured parameters not chosen for operator display, a combination of the forgoing, and/or others. It will be understood that while alerting engine 124 is illustrated as a single multitask module, the features and functions performed by this engine may be performed by multiple modules. Additionally, alerting engine 124 may comprise a child or sub-module (not illustrated) of another software module without departing from the scope of the disclosure. Alerting engine 124 may be based on any appropriate computer language such as, for example, C, C++, Java, Pearl, Visual Basic, and others.

In one aspect of operation, system 100 receives values of formation change indicators and operating conditions. After receiving the values, conversion engine 120 retrieves filtering ranges from filtering range file 114 and discards all values that fall outside their associated filtering range. For values discard, conversion engine 120 may retrieve previous values to use as the received value. After filtering the values, conversion engine 120 converts the values into the selected scale based on associated scaling functions 119. Once converted, conversion engine 120 adjusts the values by subtracting a change in the value of associated operating conditions. The adjusted values of formation change indicators are forwarded to assessment engine 122. Assessment engine 122 combines a plurality of the adjusted values to determine the occurrence of significant formation change and in response to determining significant formation change, notifies a user of system 100 of this determination. In one embodiment, assessment engine 122 determines, for those values outside their corresponding tolerance range, a difference between each adjust value and their corresponding tolerance range. Assessment engine 122 sums these differences and notifies the user of system 100 of this value by, for example, displaying the value on through GUI 106. In another embodiment, assessment engine 122 sums the values and tolerance ranges of preselected groups of formation change indicators and compares the summed values to the summed tolerance ranges to determine if any of the preselected groups fall outside their summed tolerance range. For those summed values that do, assessment engine 122 notifies the user of system 100 of the preselected group and their associated summed value.

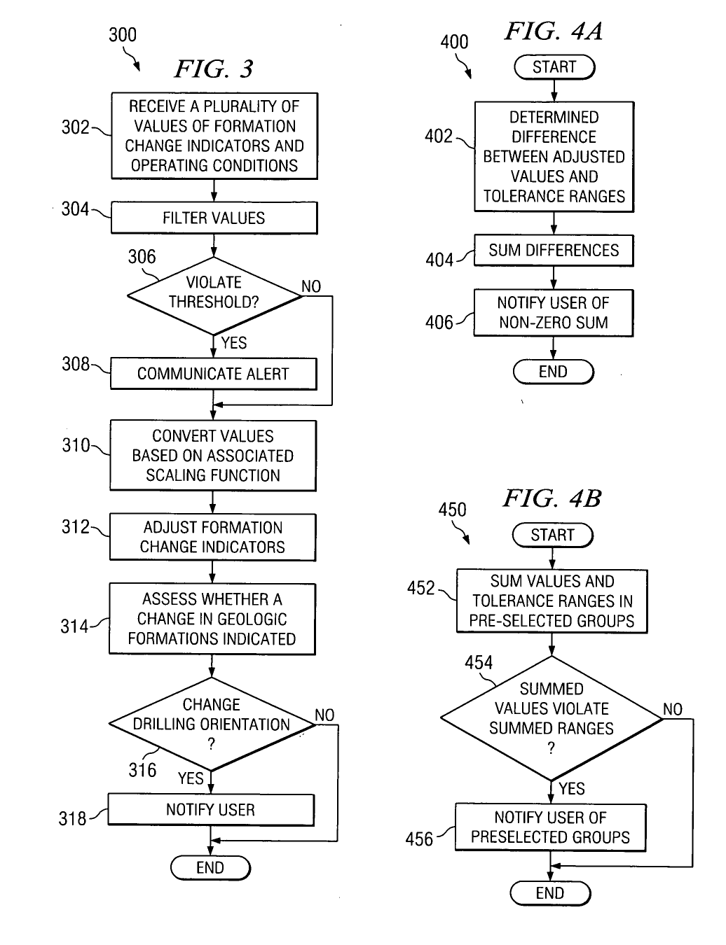

FIG. 3 is an exemplary flow diagram illustrating a method 300 for determining change in geologic formations being drilled. Method 300 is described with respect to system 100 of FIG. 2, but method 300 can also be used by any other system. Moreover, system 100 may use any other suitable techniques for performing these tasks. Thus, many of the steps in this flow chart may take place simultaneously and/or in different orders as shown. Moreover, system 100 may use methods with additional steps, fewer steps, and/or different steps, so long as the methods remain appropriate.

Method 300 begins at step 302 where a plurality of values of formation change indicators and operating conditions are received by conversion engine 120. Next, at step 304, conversion engine 120 filters the received values by discarding all values that fall outside their associated filtering range. In one embodiment, the discarded values are replaced with a previous value. If the value violates an associated threshold at decisional step 306, then, at step 308, conversion engine 120 communicates an alert to the user of system 100. If no violation is detected, then execution proceeds to step 310. At step 310, conversion engine 120 converts the values to the selected scale based on an associated scaling function 119. Conversion engine 120 adjust the scaled values based on changes in operating conditions. In one embodiment, conversion engine 120 subtracts changes in value of operating conditions from associated formation change indicators. Next, at step 314, assessment engine 122 assesses whether a change in geologic formation is indicated by combining values of formation change indicators. Two embodiments of this assessment step are illustrated in FIGS. 4A and 4B. Based on the assessment, if changes in drilling operations are required at decisional step 316, then, at step 318, assessment engine 122 notifies a user of system 100. If no changes are required at step 316, then execution ends.

FIGS. 4A-B are exemplary flow diagrams illustrating two embodiments of step 314 of FIG. 3. Methods 400 and 450 are described with respect to system 100 of FIG. 2, but methods 400 and 450 could also be used by any other system. Moreover, system 100 may use any other suitable techniques for performing these tasks. Thus, many of the steps in these flow charts may take place simultaneously and/or in different orders as shown. Moreover, system 100 may use methods with additional steps, fewer steps, and/or different steps, so long as the methods remain appropriate.

Referring to FIG. 4A, method 400 begins at step 402 where conversion engine 120 determines the difference between each adjusted value falling outside their associated tolerance range and their associated tolerance range. Next, at step 402, assessment engine 122 sums the differences. Assessment engine notifies user of system 100 of nonzero sums at step 404.

Turning to FIG. 4B, method 450 begins at step 452 where assessment engine 122 sums the adjusted values and sums the tolerance ranges in preselected groups. At decisional step 454, if the summed adjusted values violate the summed tolerance ranges of the preselected groups, then, at step 456, assessment engine 456 notifies user of system 100 of those preselected groups. If none of the preselected groups violate their summed tolerance range, then execution ends.

FIG. 5 illustrates one embodiment of a display 500 of formation change indicators 1 to 10 (FCI1 to FCI10) and overall FCI. Display 500 includes graphical bars 502 and 504. Graphical bars 502 include demarcations indicating tolerance ranges 506 of the FCI. Graphical bar 506 illustrates the summed difference between FCI and associated tolerance ranges. It will be understood that the assessment of formation change indicators may otherwise be provided. Alternatively, user of system 100 may be otherwise alerted as discussed above.

A number of embodiments of the invention have been described. Nevertheless, it will be understood that various modifications may be made without departing from the spirit and scope of the invention. For example, a peripheral benefit embedded in the technology may include user alerts that show violations that could indicate impending equipment failure (e.g. standpipe pressure decline indicating washed out tubular that can lead to parted drill string) and warn of safety issues (e.g. annular pressure decline indicating gas inflow that could result in a blowout). It is intended that the present invention encompass such changes and modifications as falling within the scope of the appended claims.

What is claimed is:

1. A method for determining change in geologic formations, comprising:
receiving a plurality of values of formation change indicators; and
for at least one formation change indicator, adjusting the value based on operating conditions.

2. The method of claim 1, further comprising determining a formation change based on the adjusted value of the at least one formation change indicator.

3. The method of claim 1, further comprising at least partially in response to the received plurality of values, automatically communicating an operator command in order to substantially maintain a drilling orientation within a subterranean formation.

4. The method of claim 3, wherein the subterranean formation comprises one or more of a thickness of less than or equal to ten feet, inconsistent bedding, undulating formation and faulted formation.

5. The method of claim 1, further comprising automatically communicating an alert when at least one of the values of the formation change indicators violates an associated threshold.

6. The method of claim 1, the formation change indicators selected from the group consisting of resistivity, density, sonic, gamma, oriented gamma, inclination, azimuth, annular pressure, vibration, tool face, rate of penetration, rotary torque, standpipe pressure, and a combination of the foregoing.

7. The method of claim 1, the operating conditions selected from the group consisting of rate of penetration, standpipe pressure, weight on bit, measured depth, rotary torque, fluid flow rate, mud weight, and a combination of the foregoing.

8. The method of claim 6, the operating conditions selected from the group consisting of rate of penetration, standpipe pressure, weight on bit, measured depth, rotary torque, fluid flow rate, mud weight, and a combination of the foregoing.

9. The method of claim 1, further comprising:
determining differences between adjusted values and associated tolerance ranges;
summing the determined differences; and
determining a formation change based on the sum.

10. The method of claim 1, further comprising:
summing adjusted values associated with a preselected group;
summing tolerance ranges associated with the preselected group;
determining that the summed adjusted values violate the summed tolerance ranges; and
communicating an alert in response to this violation.

11. The method of claim 1, further comprising changing a drilling orientation at least partially in response to the adjusted values.

12. Software for determining change in geologic formations, the software operable to:
receive a plurality of values of formation change indicators; and
for at least one formation change indicator, adjust the value based on operating conditions.

13. The software of claim 12, further operable to determine a formation change based on the adjusted value of the at least one formation change indicator.

14. The software of claim 12, further operable to at least partially in response to the received plurality of values, automatically communicating an operator command in order to substantially maintain a drilling orientation within a subterranean formation.

15. The software of claim 14, wherein the subterranean formation comprises one or more of a thickness of less than or equal to ten feet, inconsistent bedding, undulating formation and faulted formation.

16. The software of claim 12, further operable to automatically communicating an alert when at least one of the values of the formation change indicators violates an associated threshold.

17. The software of claim 12, the formation change indicators selected from the group consisting of resistivity, density, sonic, gamma, oriented gamma, inclination, azimuth, annular pressure, vibration, tool face, rate of penetration, rotary torque, standpipe pressure, and a combination of the foregoing.

18. The software of claim 12, the operating conditions selected from the group consisting of rate of penetration, standpipe pressure, weight on bit, measured depth, rotary torque, fluid flow rate, mud weight, and a combination of the foregoing.

19. The software of claim 17, the operating conditions selected from the group consisting of rate of penetration, standpipe pressure, weight on bit, measured depth, rotary torque, fluid flow rate, mud weight, and a combination of the foregoing.

20. The software of claim 12, further operable to:
determine differences between adjusted values and associated tolerance ranges;
sum the determined differences; and
determine a formation change based on the sum.

21. The software of claim 12, further operable to:
sum adjusted values associated with a preselected group;
sum tolerance ranges associated with the preselected group;
determine that the summed adjusted values violate the summed tolerance ranges; and
communicate an alert in response to this violation.

22. The software of claim 12, further operable to change a drilling orientation at least partially in response to the adjusted values.

23. A system for determining change in geologic formations, comprising:
memory operable to store information associated with a plurality of values of formation change indicators; and
one or more processors operable to:
receive a plurality of values of formation change indicators; and
for at least one formation change indicator, adjust the value based on operating conditions.

24. The system of claim 23, the processors further operable to determine a formation change based on the adjusted value of the at least one formation change indicator.

25. The system of claim 23, the processors further operable to at least partially in response to the received plurality of values, automatically communicating an operator command in order to substantially maintain a drilling orientation within a subterranean formation.

26. The system of claim 25, wherein the subterranean formation comprises one or more of a thickness of less than or equal to ten feet, inconsistent bedding, undulating formation and faulted formation.

27. The system of claim 23, the processors further operable to automatically communicating an alert when at least one of the values of the formation change indicators violates an associated threshold.

28. The system of claim 23, the formation change indicators selected from the group consisting of resistivity, density, sonic, gamma, oriented gamma, inclination, azimuth, annular pressure, vibration, tool face, rate of penetration, rotary torque, standpipe pressure, and a combination of the foregoing.

29. The system of claim 23, the operating conditions selected from the group consisting of rate of penetration, standpipe pressure, weight on bit, measured depth, rotary torque, fluid flow rate, mud weight, and a combination of the foregoing.

30. The system of claim 28, the operating conditions selected from the group consisting of rate of penetration, standpipe pressure, weight on bit, measured depth, rotary torque, fluid flow rate, mud weight, and a combination of the foregoing.

31. The system of claim 23, the processors further operable to:
determine differences between adjusted values and associated tolerance ranges;
sum the determined differences; and
determine a formation change based on the sum.

32. The system of claim 23, the processors further operable to:
sum adjusted values associated with a preselected group;
sum tolerance ranges associated with the preselected group;
determine that the summed adjusted values violate the summed tolerance ranges; and
communicate an alert in response to this violation.

33. The system of claim 23, the processors further operable to change a drilling orientation at least partially in response to the adjusted values.

34. A method for determining change in geologic formations, comprising:
receiving a plurality of values of formation change indicators; and
adjusting the values based on operating conditions;
summing adjusted values associated with a preselected group;
summing tolerance ranges associated with the preselected group;
determining that the summed adjusted values violate the summed tolerance ranges;
communicating an alert in response to this violation; and changing a drilling orientation at least partially in response to the adjusted values.
